(19) United States
(12) Patent Application Publication
(10) Pub. No.: US 2016/0258198 A1
(43) Pub. Date: Sep. 8, 2016

(54) GUIDE RAIL SYSTEM FOR GLASS SLIDING DOOR AND ASSEMBLY

(71) Applicant: SBPL SYSTEMS INC., Mille-IsIes (CA)

(72) Inventor: Serge BOUTHILLIER, Ste-Marthe-sur-le-Lac (CA)

(21) Appl. No.: 15/060,133

(22) Filed: Mar. 3, 2016

Related U.S. Application Data
(60) Provisional application No. 62/148,973, filed on Apr. 17, 2015.
(60) Provisional application No. 62/129,248, filed on Mar. 6, 2015.

(51) Int. Cl. E05D 15/06; E06B 3/46

(52) U.S. Cl. CPC E05D 15/0656; E06B 3/4636; E05Y 2900/132

(57) ABSTRACT

A guide rail system for a sliding door assembly of the type having at least a first glass panel and a second glass panel spaced apart from the first glass panel, with the glass panels movable relative to one another, the guide rail system. Base rails are configured to be connected to a bottom edge portion of each of said glass panels, the base rails each having an elongated channel. A carriage has a pair of rail ends with a bridge interconnecting the rail ends, one of the rail ends received in the elongated channel of the first glass panel and moving therein, the other of the rail ends received in the elongated channel of the second glass panel and immovable therein. A door stopper(s) is received in the elongated channel of the first glass panel and immovable therein to block the elongated channel, whereby the at least one door stopper delimits the movement of the rail end of the carriage at one end of the elongated channel of the first glass panel.

### CROSS-REFERENCE TO RELATED APPLICATIONS

The present application claims the priority of U.S. Patent Application No. 62/129,248, filed on Mar. 6, 2015, and the priority of U.S. Patent Application No. 62/148,973, filed on Apr. 17, 2015, but incorporated herein by reference.

### FIELD OF THE APPLICATION

The present disclosure generally relates to glass doors and more specifically to glass sliding door assemblies and various hardware components thereof.

### BACKGROUND OF THE ART

The use of glass as a structural paneling component is increasingly popular. Treated glass has a suitable structural integrity, in addition to all other esthetic qualities it possesses. Accordingly, domestic and commercial dwelling designs now feature various components in glass, such as doors, walls, curtain walls and the like. However, such structural components are relatively heavy as treated glass is relatively thick, whereby some support systems must be devised to support them. As the beauty of glass rests in its transparency or translucence, support systems for structural glass must be as discrete as possible.

### SUMMARY OF THE APPLICATION

It is therefore an aim of the present disclosure to provide a novel door support for glass sliding door assembly.

Therefore, in accordance with the present application, there is provided a guide rail system for a sliding door assembly of the type having at least a first glass panel and a second glass panel spaced apart from the first glass panel, with the glass panels movable relative to one another, the guide rail system comprising at least: base rails configured to be connected to a bottom edge portion of each of said glass panels, the base rails each having an elongated channel; at least one carriage having a pair of rail ends with a bridge interconnecting the rail ends, one of the rail ends received in the elongated channel of the first glass panel and moving therein, the other of the rail ends received in the elongated channel of the second glass panel and immovable therein; and at least one door stopper received in the elongated channel of the first glass panel and immovable therein to block the elongated channel, whereby the at least one door stopper delimits the movement of the rail end of the carriage at one end of the elongated channel of the first glass panel.

Further in accordance with the present disclosure, there is provided an assembly of glass panels and guide rail system comprising: at least a first glass panel and a second glass panel spaced apart from the first glass panel, with the glass panels adapted to be top-hung so as to be movable relative to one another; and a guide rail system comprising at least base rails connected to a bottom edge portion of each of said glass panels, the base rails each having an elongated channel, at least one carriage having a pair of rail ends with a bridge interconnecting the rail ends, one of the rail ends received in the elongated channel of the first glass panel and moving therein, the other of the rail ends received in the elongated channel of the second glass panel and immovable therein, and at least one door stopper received in the elongated channel of the first glass panel and immovable therein to block the elongated channel, whereby the at least one door stopper delimits the movement of the rail end of the carriage at one end of the elongated channel of the first glass panel.

### BRIEF DESCRIPTION OF THE DRAWINGS

FIG. 1 is an elevation view of a glass sliding door assembly with guide rail system of the present disclosure;

FIG. 2 is an end view of a base rail of the guide rail system of FIG. 1;

FIG. 3 is a perspective view of a carriage of the guide rail system of FIG. 1;

FIG. 4 is a perspective view of door stopper of the guide rail system of FIG. 1; and

FIG. 5 is a perspective view of a floor stopper of the guide rail system of FIG. 1.

### DESCRIPTION OF THE PREFERRED EMBODIMENTS

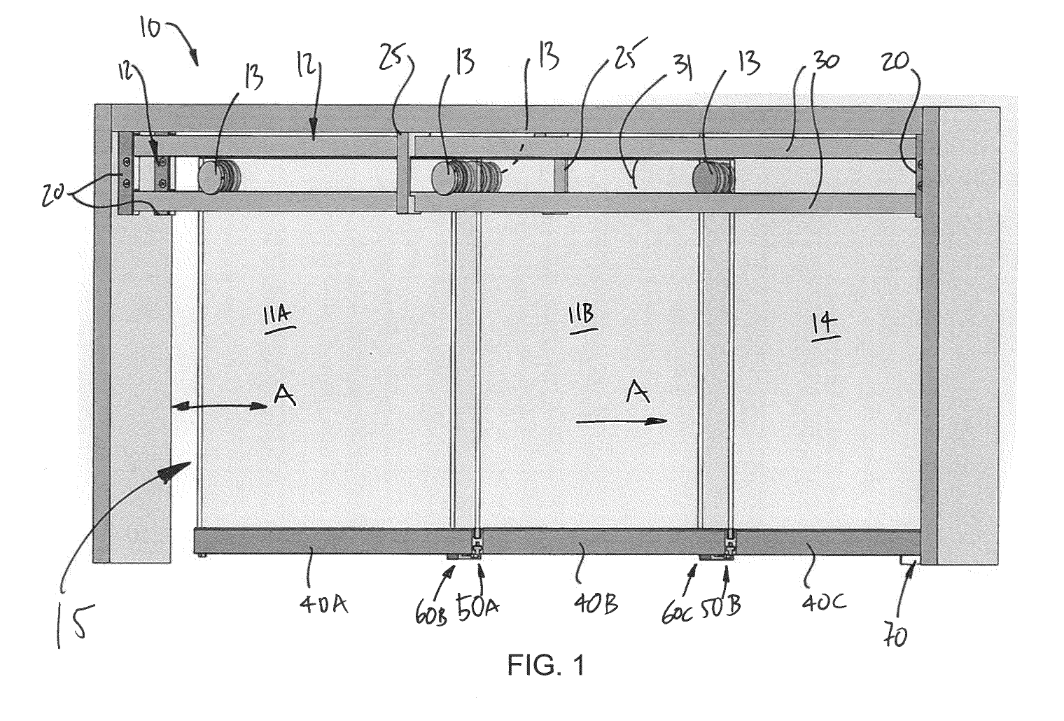

Referring to the drawings and more particularly to FIG. 1, there is illustrated a glass sliding door assembly at 10. The glass sliding door assembly 10 may feature a pair of top-hung glass sliding doors 11 (concurrently referred to as doors 11, but shown as door 11A and door 11B in FIG. 1), as shown in the embodiment of FIG. 1. It is pointed out that the glass sliding door assembly 10 may feature a single one or more than two of the glass sliding door 11. For instance, a plurality of the glass sliding doors 11 can be used as storefront gate or wall, of the type use in indoor malls, etc, or in office buildings. These are a few of many contemplated uses.

The glass sliding doors 11 are each supported by a door support 12 that is secured to a structure (e.g., walls, ceilings, etc) of a building, or may be integrated to the structure of the building. According to some embodiments, the door support 12 is secured to a structural glass wall, as illustrated hereinafter.

As shown in FIG. 1, roller units 13 are positioned at a top of the glass sliding doors 11A and interface the glass sliding doors 11 to the door support 12 such that the glass sliding doors 11 may translate along direction A. The glass doors 11 are referred to as sliding doors as this is common terminology for doors that translate in their main plane, despite the fact that roller units 13 are used in the illustrated embodiment, and thus there is little or negligible sliding movement, other than at a rail guiding system of the present disclosure as described hereinafter.

The roller units 13 are for instance of the type described in Canadian Patent No. 2,668,218 by the present Assignee (United States Patent Application Publication No. 20100307063 by the present inventor), and incorporated herewith by reference. Accordingly, a connector end of each of the roller units 13 is secured to the sliding doors 11, with the rolling portion being out of the main plane of the sliding door 11, to be received in the door support 12, as will be described hereinafter. The roller units 13 may therefore have a pulley shape with a V-type groove, square groove, etc. However, any other type of roller unit, with or without rolling elements, may be used. It is also contemplated to have the roller units 13 secured to the structure, with horizontal slots defined in the glass doors 11, as described in U.S. Pat. No. 8,881,460, for example. Moreover, any device allowing the translation of the sliding doors 11 relative to the door support 12 may be used as well, i.e., sliding pads, etc may be used instead of the roller units 13.

A fixed panel 14 may be provided in the assembly 10 and is secured adjacent to one of the glass sliding doors 11 to close off the side of an opening. Such fixed panels 14 may be referred to as sidelights. The glass sliding doors 11 move towards and away from one another in directions A to allow entrance through opening 15. The fixed panel 14 may be made of any appropriate material, but are typically made of structural tempered glass or like transparent or translucent material, as are the sliding doors 11.

Still referring to FIG. 1, the door support 12 may be of the type described in United States Patent Application Publication No. 2012/02976686 by the present inventor). For instance, end members 20 are positioned at opposed ends of the door support 12, with an intermediate members 25 is illustrated. The expression “intermediate” is used to refer to the positioning of the member 25 between ends of the door support 12 (centered or off-centered).

The intermediate member 25 is used when the door support 12 spans a relatively large opening. Similarly to the end members 20, the intermediate member 25 has sufficient structural strength to support part of the weight of the glass sliding doors 11, for instance by way of a solid body of a metallic material. The intermediate member 25 may be a double intermediate member, to support four different transoms, instead of the two individual intermediate members 25 of FIG. 1. It is observed that the spacing between the elongated vertical bodies of such a double intermediate member 25 is sufficient to allow a pair of roller units 13 to operate side by side.

Referring to FIG. 1, transoms 30 are shown as installed relative to a structure, by way of end members 20 and intermediate member 25. The transoms 30 may be referred to as beams, elongated support members, etc, and essentially consist in bars, or rails, upon which the roller units 13 will roll. Intermediate member 25 is located somewhere between the ends of the transoms 30, whereas the end members 20 receive the ends of the transoms 30. Accordingly, the intermediate member 25 may prevent any substantial downward deflection of the lower transom 30, and substantial lateral deflections of both the lower and upper transom 30 when relatively long spans of transoms 30 are used. In the illustrated embodiment, each door support 12 is associated with a respective pair of the transoms 30 that are generally parallel to one another (i.e., parallel or quasi-parallel), whereby a guideway 31 is defined between the transoms 30, and will accommodate the roller portions of the roller units 13. In FIG. 1, there are hence two pairs of transoms 30, but one of the pairs is not visible as hidden by the other pair. However, two end members 20 are visible on the left-hand side of FIG. 1, and this is indicative of the presence of a hidden pair of transoms 30. The height of the guideway 31 is selected as a function of the diameter of the roller units 13, to ensure that the roller units 13 are held captive in the guideway 31, by way of the pulley-style flanges of the roller units 13. As such, the glass doors 11 are prevented or limited from moving vertically. The transoms 30 must have sufficient strength to support the sliding doors 11, and materials such as metals are preferred. In order to be received in the receptacles 21 of the end members 20, the transoms 30 have a complementary sectional shape. Although the illustrated embodiment shows a pair of transoms 30 for each door support 12, it is considered to provide a single transom 13 per door support 12, and additional safety components may be used to ensure that the glass sliding doors 11 are not inadvertently unhooked from the door support 12.

The door support 12 of FIG. 1 is provided as an exemplary embodiment. However, other door support systems may be used. For example, door support 12 may be a glass transom, as described in U.S. Pat. No. 8,881,460, provided the glass transom is spec'd to safely support the weight of a glass sliding door 11 over the span of the transom.

Now that the glass sliding doors 11 and supporting components have been described, a guide rail system in accordance with the present disclosure is set forth. The guide rail system is provided as an alternative to floor anchor sliding guides, to ensure that the doors 11 generally remain in their sliding plane (parallel with the main plane of the doors 11, i.e., the face plane), and move along a single translation path (in one degree of freedom), parallel to the sliding plane. The guide rail system also guides the sequential sliding movement of the sliding doors 11 when in an accordion arrangement, i.e., when two sliding doors 11 can be slid to be superposed (face to face) over a common location when the door opening is fully open. In the embodiment of FIG. 1, the sliding doors 11 have an accordion arrangement in that they both may be moved to be facing the fixed panel 14. In another embodiment, the sliding doors 11 could be pocket doors to be concealed in a wall. In both configurations, the guide rail system may be used.

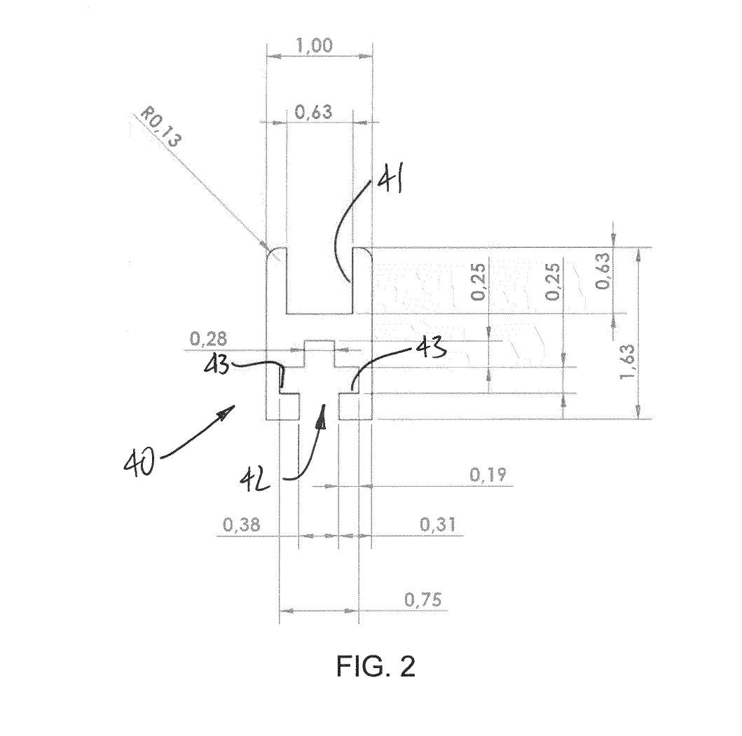

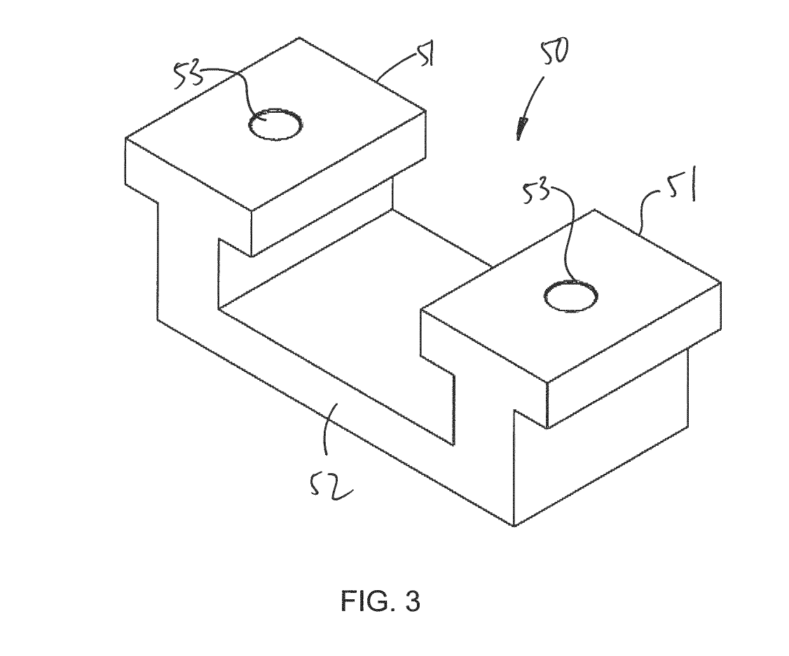

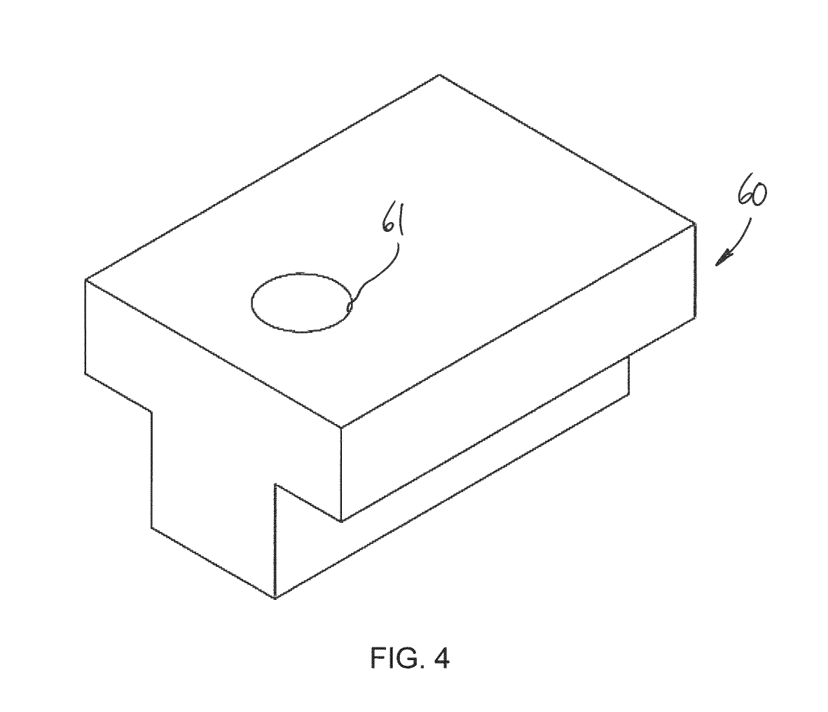

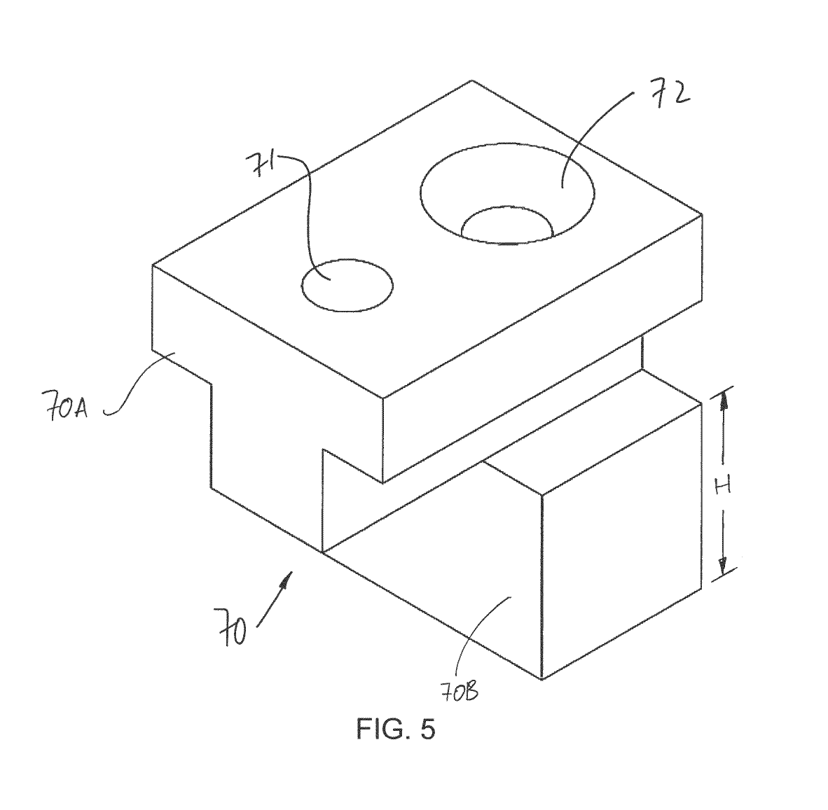

The guide rail system may have base rails 40 (FIG. 2), carriages 50 (FIG. 3), door stoppers 60 (FIG. 4) and floor stoppers 70 (FIG. 5).

Referring to FIGS. 1 and 2, the base rails 40 are mounted to a bottom edge portion of all panels that are using the guide rail system, although the fixed panel 14 may be without. In FIG. 1, the sliding doors 11A and 11B and the fixed panel 14 each have an own base rail 40. For example, the base rails 40 may be glued or force fitted to the bottom edge portion of the glass panels 11 and 14. In an embodiment, the base rails 40 are elongated extruded members (e.g., integral monolithic extrusion), although other constructions are considered. The base rails 40 may have a top vertical channel 41 for receiving the bottom edge portions of the panels, as one possible configuration to attach the base rail 40 to the glass panel. The base rails 40 further have a bottom vertical channel 42 facing downwardly when the base rail 40 is mounted to a panel. The channel 42 has a pair of side subchannels 43, although a single side subchannel 43 could be present in the vertical channel 42. The channels 42 will receive therein at least parts of the carriages 50 (FIG. 3), door stoppers 60 (FIG. 4) and floor stoppers 70 (FIG. 5). Imperial dimensions are provided in FIG. 2, as a non-limitative example, and could be scaled up or down, or widened, heightened, notably as a function of the dimension of the panels.

Referring to FIGS. 1 and 3, the carriage 50 is concurrently referred to as carriage 50, but is shown as carriages 50A and 50B in FIG. 1. Each of the carriages 50 has a pair of rail ends 51 configured to form a translational joint with the channel 42 in which it is received if the carriage 50 is not secured to the base rail 40. The rail ends 51 therefore have a shape configured to be received in the vertical channel 42, i.e., a T-shape. Other shapes are possible as a function of the shape of the channel 42. A bridge 52 interconnects the rail ends 51. The length of the bridge 52 is sized based on the spacing between the panels 11 and 14, for instance as a function of the door supports 12. A bore 53 is defined in the rail ends 51, and may be used with appropriate fasteners (e.g., screws, blots) to be anchored to the base rails 40 when necessary, as detailed below.

Referring to FIG. 4, the door stopper 60 is configured to form a translational joint with the channel 42 to be slid in a desired position along the base rail 40 to then be secured to the base rail 40. The door stopper 60 therefore has a shape configured to be received in the vertical channel 42, again the T-shape. However, the door stopper 60 may not need to have its shape complementary to that of the vertical channel 42, as the sliding feature is only used at installation. For example, the door stopper 60 may be a rectangular prism, or may have any other appropriate shape. A bore 61 is defined in the door stopper 60, and may be used with appropriate fasteners (e.g., screws, blots), for the door stopper 60 to be anchored to the base rails 40 at the desired location.

Referring to FIG. 5, the floor stopper 70 is configured to form a translational joint with the channel 42 to be slid in a desired position along the base rail 40 to then be secured to the base rail 40, and/or to the floor. A top portion 70A of the floor stopper 70 may therefore have a shape configured to be received in the vertical channel 42, again the T-shape. In similar fashion to the door stopper 60, the top portion 70A of the floor stopper 70 may not need to have its shape complementary to that of the vertical channel 42, as the sliding feature is only used at installation. For example, the top portion 70A of floor stopper 70 may be a rectangular prism, or may have any other appropriate shape. The floor stopper 70 has an additional base 70A projecting downwardly from the top portion 70A to contact the floor. A height H of the base portion 70B is therefore selected as a function of the space between the glass panel and the floor. As such, the base portion 70B may have a bottom section cut off to adjust to appropriate heights. A bore 71 is defined in the top portion 70A of the floor stopper 70, and may be used with appropriate fasteners (e.g., screws, blots) to be anchored to the base rail 40 at the desired location, although it may not be necessary to secure the top portion 70A to the base rail 40 although it provides added strength. A bore 72 is also defined in the floor stopper 70, and may be used with appropriate fasteners (e.g., screws, blots) to be anchored to the floor at the desired location, and thus through the base portion 70B. The bore 72 is shown as having a countersink for receiving a given type of fastener, as an exemplary configuration.

Referring to FIG. 1, an installation of the guide rail system is shown. The door 11A has the carriage 50A in its base rail 40A, the carriage 50A anchored to the base rails 40A so as to be immovable relative to the door 11A. The door 11B has a door stopper 60B at one end, and the carriage 50B at the other end, both the stopper 60B and the carriage 50B being anchored so as not to be movable relative to the door 11B. On the other hand, the carriage 50A, having its rail end anchored to the door 11A, is not anchored to the door 11B and may therefore slide along the base rail 40B of the door 11B.

Therefore, when the door 11A is moved toward the right in FIG. 1, the carriage 50A will move with the door 11A (it is fixed to it) and slide along the bottom edge portion of the door 11B in the base rail 40B, until the rail end 51 of carriage 50A comes into abutment with the carriage 50B fixed to the door 11B. At that contact, the door 11A will be prevented from moving further along the door 11B. Rather, the door 11A will entrain the door 11B further to the right in FIG. 1, the doors 11A and 11B moving concurrently because of the contact between the carriage 50A and the carriage 50B. Eventually, the rail end of the carriage 50B, free to slide in the base rail 40C of the fixed panel 14, will come into contact with the floor stopper 70. This delimits the rightward movement of the doors 11A and 11B. The opening 15 delimited by the doors 11A and 11B is to its maximum open state, with the doors 11A and 11B generally superposed with the fixed panel 14.

When the door 11A is moved toward the left from the maximum open state, the carriage 50A will slide along the bottom edge portion of the door 11B without entraining the door 11B, until the rail end 51 of carriage 50A comes into abutment with the door stopper 60B fixed to the door 11B. At that contact, the door 11A will be prevented from moving further along the door 11B. From that point on, any further movement of the door 11A toward the left in FIG. 1 will entrain the door 11B, the doors 11A and 11B moving concurrently. Eventually, the rail end of the carriage 50B, free to slide in the base rail 40C of the fixed panel 14, will come into contact with the door stopper 60C located at the end of the base rail 40 on the fixed panel 14. This delimits the leftward movement of the doors 11A and 11B. The opening 15 delimited by the doors 11A and 11B is closed. Although not shown, a locking device may be used to lock the doors 11A and 11B in this closed arrangement. A single locking device may be sufficient for all doors 11. Other arrangements are contemplated, for instance by reversing the roles of the carriages 50, etc. The carriage 50A could for example be secured to the fixed panel 11B, while the door 11A could have a pair of stoppers 60.

In these movements, the doors 11A and 11B and the fixed panel 14 are maintained substantially parallel by the constraints imposed by the guide rail system. The presence of the floor stopper 70 may ensure that the doors 11A and 11B are prevented from moving out of plane, and could be useful in an embodiment in which there is no fixed panel 14, just two sliding doors 11. However, it may not be necessary to use the floor stopper 70, if one of the glass panels is fixed to a structure. For example, in FIG. 1, the rail 40C is connected to the fixed panel 14, immovable at it is fixed to the structure of the building. In such a case, the fixed nature of the fixed panel 14 will prevent out of plane movements for the doors 11A and 11B, via their interconnection with the guide rail system. The floor stopper 70 or another one of the door stoppers 60 could be used as guard to prevent contact between the doors and the structure.

The guide rail system described above does not feature floor mounted hardware (rails, stoppers) in the entrance defined by the doors 11A and 11B. In other words, when the doors 11A and 11B are fully opened, there is no floor obstacle in the door opening upon which a user may trip. The guide rail system is also sleek, as the carriages 50 and stoppers 60 are discrete, and the base rails 40 are spaced from the floor (although it is contemplated to have the base rails contacting the floor on one side). It is considered to provide the base rails 40 with a longer edge surface on one side to conceal the carriage 50 from a front view.

The guide rail system could be used with not flat glass panels as well, with the base rails matching a curvature of the glass panels. The carriage 50, and stoppers 60/70 may be made of any appropriate material, but are preferably made of a polymer.

1. A guide rail system for a sliding door assembly of the type having at least a first glass panel and a second glass panel spaced apart from the first glass panel, with the glass panels movable relative to one another, the guide rail system comprising at least:
base rails configured to be connected to a bottom edge portion of each of said glass panels, the base rails each having an elongated channel;
at least one carriage having a pair of rail ends with a bridge interconnecting the rail ends, one of the rail ends received in the elongated channel of the first glass panel and moving therein, the other of the rail ends received in the elongated channel of the second glass panel and immovable therein; and
at least one door stopper received in the elongated channel of the first glass panel and immovable therein to block the elongated channel, whereby the at least one door stopper delimits the movement of the rail end of the carriage at one end of the elongated channel of the first glass panel.

2. The guide rail system according to claim 1, wherein the glass panels are parallel to a common plane with at least one of the glass panels being translatable along the common plane, one of the rail ends received in the elongated channel of the first glass panel being translatable therein.

3. The guide rail system according to claim 1, further comprising a floor stopper received in the base rail of one of the glass panels and configured to be secured to a floor, wherein the first glass panel and the second glass panel are movable relative to the floor, the floor stopper delimiting movement of the glass panel by contact with one of carriage and the door stopper in the base rail.

4. The guide rail system according to claim 1, wherein each said base rail is an integral monolithic extrusion.

5. The guide rail system according to claim 1, wherein the elongated channel of each said base rail has an opening oriented downwardly.

6. The guide rail system according to claim 1, wherein each said base rail comprises another elongated channel having an opening oriented upwardly and configured for receiving the bottom edge portion of the glass panel.

7. The guide rail system according to claim 1, wherein the rail ends have a T-shaped section.

8. The guide rail system according to claim 1, wherein a bottommost edge of each said base rail is spaced from the floor.

9. An assembly of glass panels and guide rail system comprising:
at least a first glass panel and a second glass panel spaced apart from the first glass panel, with the glass panels adapted to be top-hung so as to be movable relative to one another; and
a guide rail system comprising at least
base rails connected to a bottom edge portion of each of said glass panels, the base rails each having an elongated channel,
at least one carriage having a pair of rail ends with a bridge interconnecting the rail ends, one of the rail ends received in the elongated channel of the first glass panel and moving therein, the other of the rail ends received in the elongated channel of the second glass panel and immovable therein, and
at least one door stopper received in the elongated channel of the first glass panel and immovable therein to block the elongated channel, whereby the at least one door stopper delimits the movement of the rail end of the carriage at one end of the elongated channel of the first glass panel.

10. The assembly according to claim 9, wherein the glass panels are parallel to a common plane with at least one of the glass panels being translatable along the common plane, one of the rail ends received in the elongated channel of the first glass panel being translatable therein.

11. The assembly according to claim 9, further comprising a floor stopper received in the base rail of one of the glass panels and configured to be secured to a floor, wherein the first glass panel and the second glass panel are movable relative to the floor, the floor stopper delimiting movement of the glass panel by contact with one of carriage and the door stopper in the base rail.

12. The assembly according to claim 9, wherein each said base rail is an integral monolithic extrusion.

13. The assembly according to claim 9, wherein the elongated channel of each said base rail has an opening oriented downwardly.

14. The assembly according to claim 9, wherein each said base rail comprises another elongated channel having an opening oriented upwardly for receiving the bottom edge portion of the glass panel.

15. The assembly according to claim 9, wherein the rail ends have a T-shaped section.

16. The assembly according to claim 9, wherein a bottommost edge of each said base rail is spaced from the floor.

17. The assembly according to claim 9, wherein one of the first glass panel and the second glass panel is movable relative to the floor, while the other of the first glass panel and the second glass panel is fixed relative to the floor.

18. The assembly according to claim 9, wherein the first glass panel and the second glass panel are movable relative to the floor, and wherein a third glass panel is fixed relative to the door, one of said carriage being between the first glass panel and the second glass panel, and another of said carriage being between the one of the first and second glass panels and the third glass panel.
